(19) United States
(12) Patent Application Publication
(10) Pub. No.: US 2012/0144148 A1
(43) Pub. Date: Jun. 7, 2012

(54) METHOD AND DEVICE OF JUDGING COMPRESSED DATA AND DATA STORAGE DEVICE INCLUDING THE SAME

(75) Inventors: Mankeun SEO, Hwaseong-si (KR); Junjin KONG, Yongin-si (KR); KyoungLae CHO, Yongin-si (KR); Hong Rak SON, Anyang-si (KR)

(73) Assignee: SAMSUNG ELECTRONICS CO., LTD., Suwon-si (KR)

(21) Appl. No.: 13/241,352

(22) Filed: Sep. 23, 2011

(30) Foreign Application Priority Data
Dec. 6, 2010 (KR) 10-2010-0123788

(51) Int. Cl. G06F 12/00

(52) U.S. Cl. 711/170; 711/E12.001

(57) ABSTRACT

A write method of a data storage device including a storage media includes receiving data to be stored in the storage media; judging whether the received data is compressed data, without externally provided additional information; and selectively compressing the received data according to the judgment result, wherein the judging whether the received data is compressed data is made based on a distribution of actual symbols included in at least part of the received data.

### CROSS-REFERENCE TO RELATED APPLICATIONS

This application claims priority from Korean Patent Application No. 10-2010-0123788 filed Dec. 6, 2010, in the Korean Intellectual Property Office, the disclosure of which is incorporated herein by reference in its entirety.

### BACKGROUND

1. Field

Exemplary embodiments relate to electronic devices, and more particularly, to a data storage device.

2. Description of the Related Art

As it is known in the art, computer systems generally use several types of memory systems. For example, computer systems generally use so called main memory comprised of semiconductor devices typically having the attribute that the devices can be randomly written to and read from with comparable and very fast access times and thus are commonly referred to as random access memories. However, since semiconductor memories are relatively expensive, other higher density and lower cost memories are often used. For example, other memory systems include magnetic disk storage systems. In case of magnetic disk storage systems, generally, access times are in the order of tens of milliseconds. On the other hand, in case of main memory, the access times are in the order of hundreds of nanoseconds. Disk storage is used to store large quantities of data which can be sequentially read into main memory as needed. Another type of disk like storage is solid state disk storage (SSD, also called solid state drive). SSD is a data storage device that uses memory chips, such as SDRAM, to store data, instead of the spinning platters found in conventional hard disk drives.

The term “SSD” is used for two different kinds of products. The first type of SSD, based on fast, volatile memory such as SDRAM, is categorized by extremely fast data access and is used primarily to accelerate applications that are held back by the latency of disk drives. Since this SSD uses volatile memory, it typically incorporates internal battery and backup disk systems to ensure data persistence. If power is lost for whatever reason, the battery keeps the unit powered long enough to copy all data from RAM to backup disk. Upon the restoration of power, data is copied back from backup disk to RAM and the SSD resumes normal operation. The first type of SSD is especially useful on a computer which is already has the maximum amount of RAM. The second type of SSD uses flash memory to store data and is generally used to replacement of a hard disk drive.

### SUMMARY

One or more exemplary embodiments provide a write method of a data storage device including a storage media. In accordance with an aspect of an exemplary embodiment, a write method includes receiving data to be stored in the storage media; judging whether the received data is compressed data, without externally provided additional information; and selectively compressing the received data according to the judgment result, wherein the judging whether the received data is compressed data is made based on a distribution of actual symbols included in at least part of the received data.

In accordance with an aspect of another exemplary embodiment, a data storage device provides a storage media; and a controller configured to control the storage media. The controller is configured to judge whether data to be stored in the storage media is compressed data without externally provided additional information and to selectively compress the data to be stored in the storage media according to the judgment result, the judging whether the received data is compressed data being made based on a distribution of actual symbols included in at least part of the received data.

### BRIEF DESCRIPTION OF THE DRAWINGS

The above and other objects and features will become apparent from the following description with reference to the following figures, wherein like reference numerals refer to like parts throughout the various figures unless otherwise specified, and wherein:

FIG. 1 is a block diagram illustrating a data storage device according to an exemplary embodiment;

FIG. 2 is a block diagram of a controller illustrated in FIG. 1 according to an exemplary embodiment;

FIG. 3 is a block diagram pf a data deviation detection block illustrated in FIG. 2 according to an exemplary embodiment;

FIG. 4 is a flow chart for describing a write method of a data storage device according to an exemplary embodiment;

FIG. 5 is a flow chart for describing a data deviation detecting operation of step S200 in FIG. 4 according to an exemplary;

FIG. 6 is a diagram for describing data compression of a data storage device described in FIG. 5 according to an exemplary embodiment;

FIG. 7 is a flow chart for describing a data deviation detecting operation of step S200 in FIG. 4 according to another exemplary embodiment;

FIG. 8 is a diagram for describing data compression of a data storage device described in FIG. 7 according to another exemplary embodiment;

FIG. 9 is a flow chart for describing a write method of a data storage device according to another exemplary embodiment;

FIG. 10 is a block diagram of a data deviation detection block illustrated in FIG. 2 according to an exemplary embodiment;

FIG. 11 is a block diagram of a controller illustrated in FIG. 1 according to another exemplary embodiment;

FIG. 12 is a block diagram illustrating a solid state drive to which a data deviation detecting scheme according to exemplary embodiments is applied;

FIG. 13 is a block diagram of storage using a solid state drive illustrated in FIG. 12;

FIG. 14 is a block diagram of a storage server using a solid state drive illustrated in FIG. 12;

FIG. 15 is a block diagram illustrating storage according to another exemplary embodiment;

FIG. 16 is a block diagram of a storage server using storage illustrated in FIG. 15;

FIG. 17 through FIG. 19 are diagrams illustrating systems utilizing a data storage device according to exemplary embodiments; and

FIG. 20 is a block diagram illustrating a computing system including a non-volatile memory device according to an exemplary embodiment.

### DETAILED DESCRIPTION

The inventive concept is described more fully hereinafter with reference to the accompanying drawings, in which exemplary embodiments of the inventive concept are shown. This inventive concept may, however, be embodied in many different forms and should not be construed as limited to the exemplary embodiments set forth herein. Rather, these exemplary embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular exemplary embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

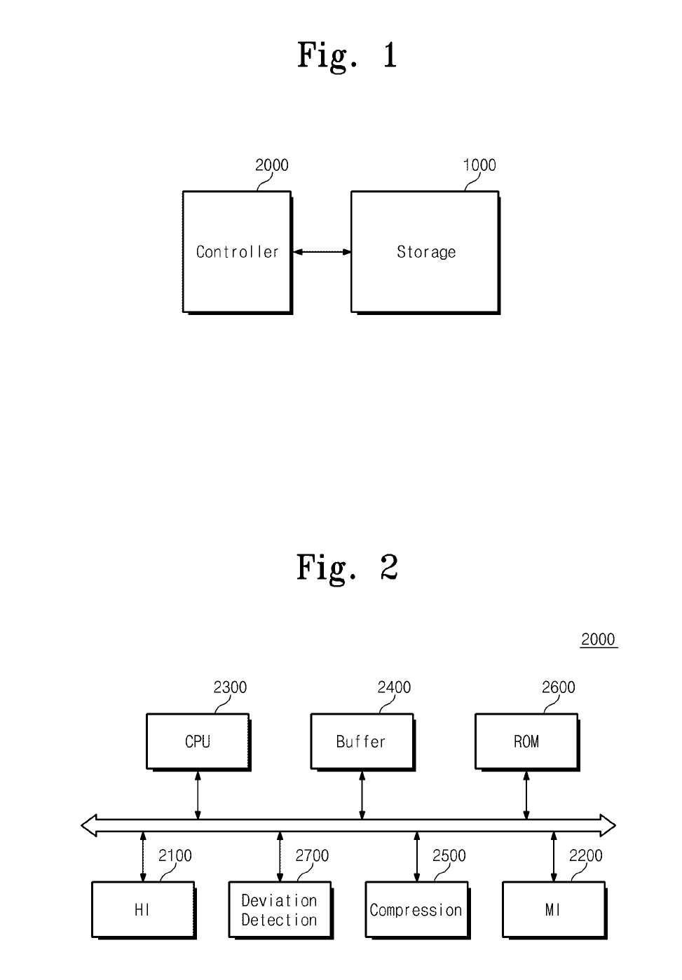

FIG. 1 is a block diagram illustrating a data storage device according to an exemplary embodiment.

Referring to FIG. 1, a data storage device may include a storage media 1000 and a controller 2000. The storage media 1000 may be used to store various types of data information such as texts, graphics, software codes, and the like. The storage media 1000 may be constituted of non-volatile memories such as a NAND flash memory, a NOR flash memory, PRAM, FeRAM, MRAM, and the like, for example. It is well understood that non-volatile memories applied to the storage media 1000 are not limited to this disclosure.

The controller 2000 may be configured to control the storage media 1000 in response to an external request. The controller 2000 may be configured to judge whether data provided from an external device is compressed data or raw data, i.e., non-compressed data, without additional information. If the data provided from the external device is judged to be compressed data, the controller 2000 may be configured to store the data provided from the external device in the storage media 1000 without performing further compression. If the data provided from the external device is judged to be raw data, the controller 2000 may be configured to compress it and to store the compressed data in the storage media 1000. This will be more fully described hereinafter.

As data compression is applied to the data storage device, it is possible to use the storage media 1000 efficiently. For example, it is possible to store a large amount of data with a low cost. Further, as data compression is applied to the data storage device, the amount of data transferred between the storage media 1000 and the controller 2000 can be reduced. That is, with data compression, a time taken to transfer data between the storage media 1000 and the controller 2000 may be shortened.

FIG. 2 is a block diagram of a controller illustrated in FIG. 1 according to an exemplary embodiment.

Referring to FIG. 2, a controller 2000 may include the first interface 2100, the second interface 2200, CPU 2300 as a processing unit, a buffer 2400, a compression block 2500, and a data deviation detection block 2700.

The first interface 2100 may be configured to interface with an external device (or, a host). The second interface 2200 may be configured to interface with a storage media 1000 illustrated in FIG. 1. The processing unit, that is, the CPU 2300 may be configured to control an overall operation of the controller 2000. For example, the CPU 2300 may be configured to operate firmware such as a memory translation layer (MTL) stored in the ROM 2600. The MTL may be used to manage memory mapping information. But, it is well understood that a role of the MTL is not limited to this disclosure. For example, the MTL may be used to manage wear-leveling, defective blocks, data retention upon unexpected power-off, and the like with respect to the storage media 1000. The ROM 2600 can be used selectively (or, optionally). For example, firmware to be stored in the ROM 2600 is stored in the storage media 1000, and is loaded onto the buffer 2400 at power-up.

The buffer 2400 may be used to temporarily store data transferred from an external device via the first interface 2100. The buffer 2400 may be used to temporarily store data transferred from the storage media 1000 via the second interface 2200. Further, the buffer 2400 may be used as a work memory. The buffer 2400 may be formed of, for example but not limited to, DRAM, SRAM, or a combination of DRAM and SRAM. The compression block 2500 may operate responsive to the control of the CPU 2300 (or, the control of the MTL executed by the CPU 2300) and be configured to compress data sequentially provided from the buffer 2400 by a compression unit. Compressed data may be stored in the storage media 1000 via the second interface 2200. Further, the compression block 2500 may operate responsive to the control of the CPU 2300 (or, the control of the MTL executed by the CPU 2300) and be configured to release the compression of data read out from the storage media 1000.

The data deviation detection block 2700 may be configured to detect whether data being stored in the storage media 1000 (for example, data stored in the buffer 2400 or data provided from an external device) is compressed data or raw data. If data being stored in the storage media 1000, for example, data stored in the buffer 2400 or data provided from an external device, is judged to be compressed data, no compression is executed with respect to data being stored in the storage media 1000. In this case, a compression function of the compression block 2500 may be turned off. This means that data being stored in the storage media 1000 (for example, data stored in the buffer 2400 or data provided from an external device) is stored directly in the storage media 1000 without a further compression process being performed by the compression block 2500. If data being stored in the storage media 1000 (for example, data stored in the buffer 2400 or data provided from an external device) is judged to be raw data, compression is executed with respect to data being stored in the storage media 1000. In this case, a compression function of the compression block 2500 may be turned on. This means that data being stored in the storage media 1000 (for example, data stored in the buffer 2400 or data provided from an external device) is firstly compressed by the compression block 2500 and the compressed data is then stored in the storage media 1000.

As can be understood from the above description, the compression function of the compression block 2500 may be executed selectively according to a detection result of the data deviation detection block 2700. The turning on or off of the compression block may be implemented in hardware (for example, register) or in software according to a detection result of the data deviation detection block 2700.

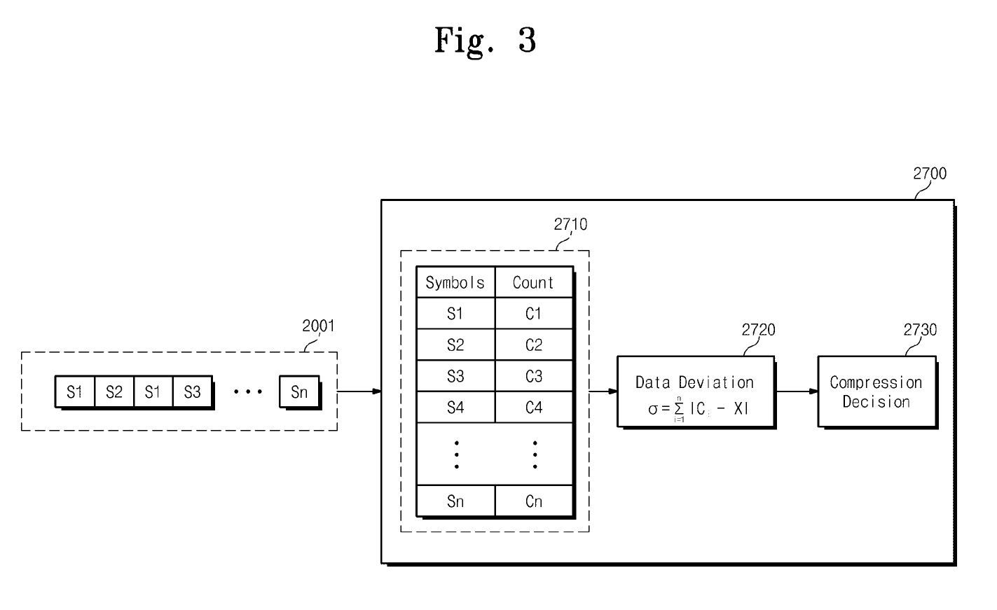

FIG. 3 is a block diagram of a data deviation detection block illustrated in FIG. 2 according to an exemplary embodiment.

Data being stored in a storage media 1000 may be sent to a buffer 2400 from an external device. Before the data in the buffer 2400 is stored in the storage media 1000, a data deviation detection block 2700 may judge whether the data in the buffer 2400 is compressed data. The data in the buffer 2400, for example, may be data transferred according to a write request of the external device. For ease of description, a compressed data unit of the compression block 2500 is called a chunk. The data in the buffer 2400 may be formed of one or more chunks. The compressed data unit of the compression block 2500 may be fixed or varied.

The data deviation detection block 2700 may detect a data deviation σ based on data (hereinafter, called a data chunk) corresponding to one chunk provided from the buffer 2400 and determine whether to compress data (or, activation/inactivation of a compression block 2500) according to the data deviation σ. A data chunk 2001, as illustrated in FIG. 3, may be formed of a plurality of symbols. Each symbol may be formed of a plurality of bits. For example, each symbol may be formed of eight bits. As another example, each symbol can be formed of either less bits than a byte or M-word (M being an integer being 1 or more). When each symbol is formed of eight bits, 256 (2⁸) symbols may exit. For example, when each symbol is formed of two bits, four different symbols (for example, 00, 01, 10, and 11) may exit. Alternatively, when each symbol is formed of a word (16 bits), 65536 (2¹⁶) symbols may exit. In an exemplary embodiment, the number of symbols of a data chunk may be determined according to a symbol size.

As illustrated in FIG. 3, the data deviation detection block 2700 may include a symbol counting part 2710, a data deviation calculating part 2720, and a compression decision part 2730. The symbol counting part 2710 may count the occurrence/event number of actual symbols included in the data chunk 2001 provided from the buffer 2400. For example, the symbol counting part 2710 may increase a count value C1 corresponding to a symbol S1 by one whenever a symbol having a value of S1 is detected. As symbols of the data chunk 2001 are transferred to the symbol counting part 2710, there are decided count values corresponding to actual symbols in the data chunk 2001. The symbol counting part 2710 may judge whether symbols in one data chunk 2001 are all received. These actions may be performed until all symbols in one data chunk 2001 are received.

The data deviation calculating part 2720 may calculate a data deviation σ according to the following equation.

$$σ = {\sum }_{i = 1}^{n} \vert Ci - X \vert$$

In the equation, Ci indicates the occurrence/event number of each symbol (hereinafter, called an actual symbol number), and X indicates the occurrence/event number (hereinafter, called an ideal symbol number) of each of all symbols expressible under the assumption that data is compressed ideally. For example, assuming that a data chunk is formed of 4096 symbols and one symbol is formed of eight bits, the ideal symbol number X may be 16 (=4096/256). The ideal symbol number X may be decided by a data chunk size and a symbol size. That is, the ideal symbol number X may indicate the average symbol number of expressible symbols decided according to a symbol size. The ideal symbol number X may be calculated by the data deviation calculating part 2720 based on a symbol size and a data chunk size or set by a predetermined value. In an exemplary embodiment, the data deviation σ may be used to indicate a distribution of actual symbols in the data chunk 2001.

The compression decision part 2730 may decide whether to compress data (or, activate/inactivate compression block 2500) according to the data deviation σ calculated by the data deviation calculating part 2720. For example, when a value of the data deviation σ exceeds a reference value, the compression decision part 2730 decides the data in the buffer 2400 (data being stored in a storage media 1000) as raw data (or, uncompressed data). When no value of the data deviation σ exceeds a reference value, the compression decision part 2730 decides the data in the buffer 2400 (or, data being stored in the storage media 1000) as compressed data. Data in the buffer 2400 may be compressed by the compression block 2500 selectively according to the decision result of the compression decision part 2730.

As described above, whether data being stored in the storage media 1000 is compressed data or raw/uncompressed data may be judged on the basis of one data chunk, which is provided to the data deviation detecting part 2700 from the buffer 2400. On the other hand, a data chunk provided to the data deviation detecting block 2700 can be data transferred to the buffer 2400 from an external device.

In some exemplary embodiments, whether data being stored in the storage media 1000 is compressed data or raw/uncompressed data may be determined on the basis of data deviation values of plural data chunks. Alternatively, activation/inactivation of the compression block 2500 can be accomplished independently with respect to all data chunk of data being stored in the storage media 1000.

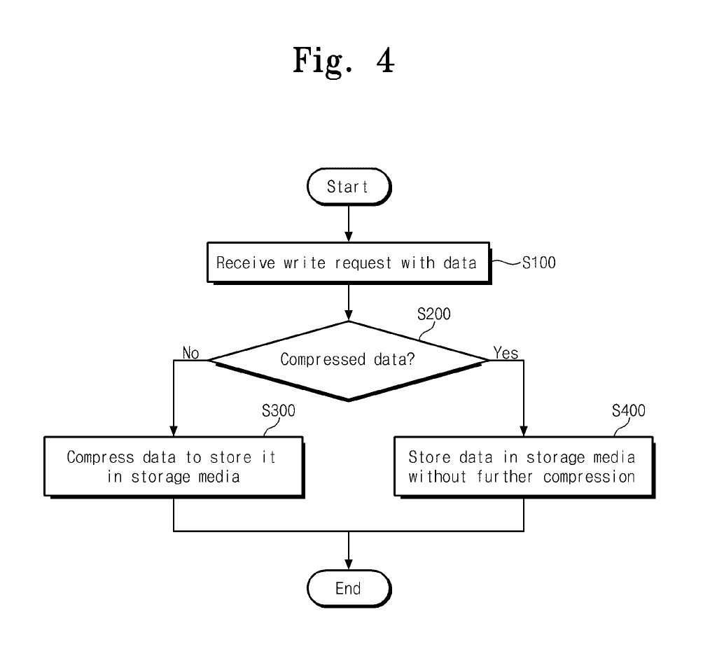

FIG. 4 is a flow chart for describing a write method of a data storage device according to an exemplary embodiment.

In step S100, as data provided from an external device, data being stored in a storage media 1000 may be stored in a buffer 2400 at a write request. Once data being stored in a storage media 1000 is stored in the buffer 2400, in step S200, there is judged whether data being stored in the storage media 1000 is compressed data. This operation is referred to as a data deviation detecting operation. The data deviation detecting operation may be made by a data deviation detecting block 2700 described in FIG. 3. On the other hand, as will be described hereinafter, the data deviation detecting operation can be performed in software.

If data being stored in the storage media 1000 is raw data, the write method proceeds to step S300, in which data in the buffer 2400 is compressed by the compression block 2500 and the compressed data is stored in the storage media 1000. Afterwards, the write method ends. If data being stored in the storage media 1000 is compressed data, the write method proceeds to step S400, in which compressed data in the buffer 2400 is stored directly in the storage media 1000 without performing further compression.

In FIG. 4, there is illustrated an example that an operation of step S200 is performed after data being stored in the storage media 1000 is stored in the buffer 2400. But, the operation of step S200 can be performed when a part of data being stored in the storage media 1000 is stored in the buffer 2400. Alternatively, the operation of step S200 can be performed based on data transferred to the buffer 2400 from an external device after an input of a write request.

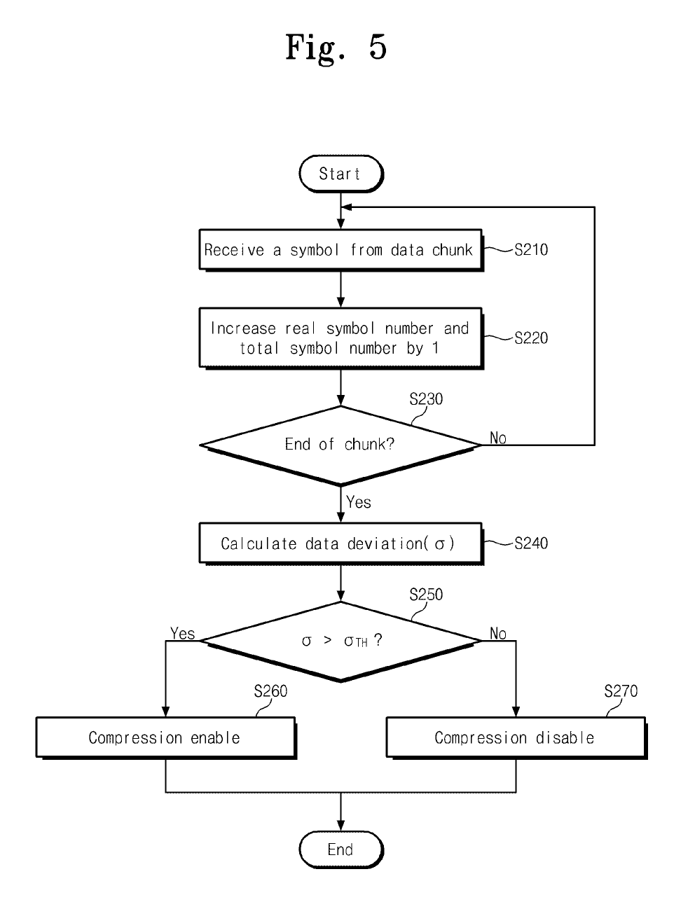

FIG. 5 is a flow chart for describing a data deviation detecting operation of step S200 in FIG. 4 according to an exemplary embodiment.

In step S210, one symbol included in a data chunk 2001 may be sent to a data deviation detecting block 2700 from a buffer 2400. This may be accomplished under the control of CPU 2300 (or, firmware executed by the CPU 2300). Alternatively, transferring of data to the data deviation detecting block 2700 from the buffer 2400 may be performed according to a request of the data deviation detecting block 2700. In step S220, a symbol counting part 2710 of the data deviation detecting part 2700 may count the actual symbol number based on the received symbol. That is, a count value Ci of an actual symbol Si may increase by 1. At this time, the symbol counting part 2710 may increase the total symbol number by 1. In step S230, the symbol counting part 2710 may judge whether an input symbol is a last symbol of the data chunk 2001, based on the total symbol number.

If the input symbol is judged not to be the last symbol, the write method proceeds to step S210. The steps S210 to S230 may be repeated until the input symbol is judged to be the last symbol. If the input symbol is judged to be the last symbol, the write method proceeds to step S240, in which a data deviation calculating part 2720 may calculate a data deviation σ based on the ideal symbol number X and count values Ci generated by the symbol counting part 2710. Calculation of the data deviation σ may be made according to the above-described equation. Herein, the ideal symbol number X may be determined by a data chunk size and a symbol size. The ideal symbol number X may be calculated by the data deviation calculating part 2720 using a data chunk size and a symbol size or may be set to a fixed value.

In step S250, a compression decision part 2730 may judge whether a value of the data deviation σ calculated by the data deviation calculating part 2720 exceeds a reference value σ_{TH}. If a value of the data deviation σ calculated by the data deviation calculating part 2720 exceeds the reference value σ_{TH}, the write method proceeds to step S260. In step S260, a compression function of a compression block 2500 may be activated. That a value of the data deviation σ calculated by the data deviation calculating part 2720 exceeds the reference value σ_{TH}, means that a large deviation between the ideal symbol number X and the actual symbol number Ci exists. In other words, the greater a deviation between the ideal symbol number X and the actual symbol number Ci, the higher the probability that data in a buffer 2400 is raw data. For this reason, the compression function of the compression block 2500 may be activated. The activation of the compression function of the compression block 2500 may be made in hardware or in software.

On the other hand, if a value of the data deviation σ calculated by the data deviation calculating part 2720 does not exceed the reference value σ_{TH}, the write method proceeds to step S270, in which the compression function of the compression block 2500 is inactivated. That a value of the data deviation σ calculated by the data deviation calculating part 2720 does not exceed the reference value σ_{TH}, means that a small deviation between the ideal symbol number X and the actual symbol number Ci exists. In other words, the smaller a deviation between the ideal symbol number X and the actual symbol number Ci, the higher the probability that data in a buffer 2400 is compressed data. For this reason, the compression function of the compression block 2500 may be inactivated. The activation of the compression function of the compression block 2500 may be made in hardware or in software.

Afterwards, as activation or inactivation of the compression block 2500 is decided as described above, data stored in the buffer 2400 may be compressed by the compression block 2500 under the control of CPU 2300 (or, firmware executed by the CPU 2300) and stored in the storage media 1000, or directly stored in the storage media 1000 without being compressed by the compression block 2500, based on a value of the data deviation σ.

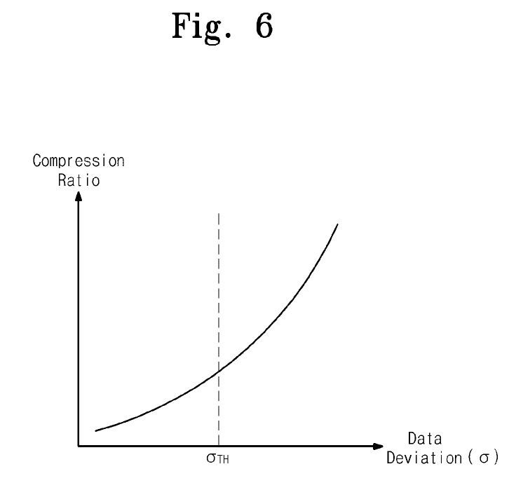

FIG. 6 is a diagram for describing data compression of a data storage device described in FIG. 5 according to an exemplary embodiment.

A data deviation σ may be calculated as described in FIGS. 3 to 5. If the calculated data deviation σ is more than a reference value σ_{TH}, as described in FIG. 6, the compression ratio may be high. The compression ratio may be decided by dividing a size of compressed data by a size of uncompressed data. That the compression ratio is high indicates that a size of data compressed by a compression block 2500 is small. That is, that the calculated data deviation σ is more than the reference value σ_{TH}, indicates that the compression ratio of data stored in a buffer 2400 is high.

If the calculated data deviation σ is less than the reference value σ_{TH}, as described in FIG. 6, the compression ratio may be low. That the compression ratio is low indicates that a size of data compressed by a compression block 2500 is large. That is, that the calculated data deviation σ is less than the reference value σ_{TH}, indicates that the compression ratio of data stored in a buffer 2400 is low. Accordingly, it is possible to predict the compression efficiency of data in the buffer 2400, together with judging whether data in the buffer 2400 is compressed data.

There is described an example that the data deviation detecting operation described in FIG. 5 is implemented through the data deviation detecting block 2700 in hardware. But, it is well understood that the data deviation detecting operation described in FIG. 5 may be implemented in software. For example, a program for executing the data deviation detecting operation may be stored in ROM 2600 illustrated in FIG. 2. The program, for example, may be included in the above-described memory translation layer. The data deviation detecting operation of the memory translation layer may be performed under the control of CPU 2300 illustrated in FIG. 2. In this case, although not illustrated in figures, a controller 2000 may be configured to have remaining elements 2100 to 2600 other than the data deviation detecting block 2700 in FIG. 2.

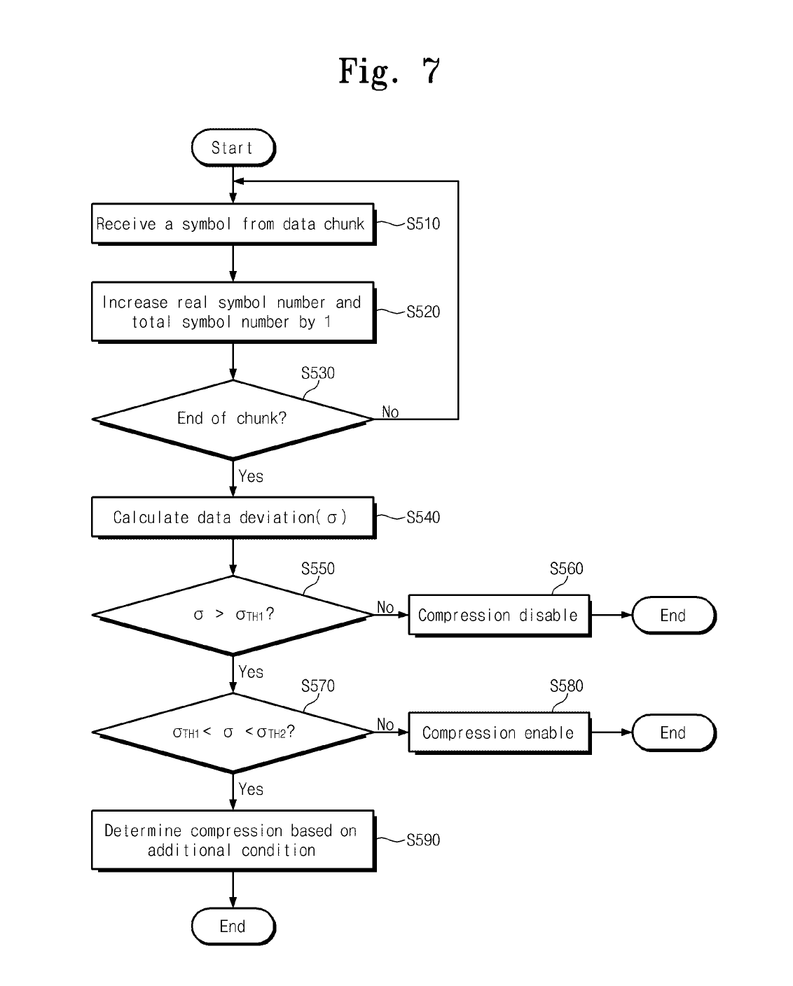

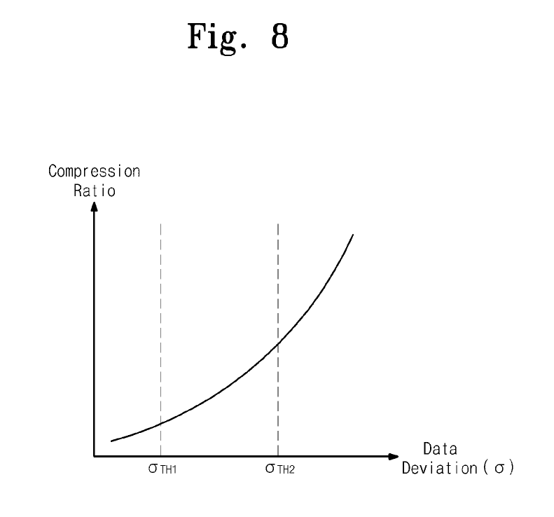

FIG. 7 is a flow chart for describing a data deviation detecting operation of step S200 in FIG. 4 according to another exemplary embodiment.

In step S510, one symbol included in a data chunk 2001 may be sent to a data deviation detecting block 2700 from a buffer 2400. This may be accomplished under the control of CPU 2300 (or, firmware executed by the CPU 2300). In step S520, a symbol counting part 2710 of the data deviation detecting part 2700 may count the actual symbol number Ci based on the received symbol. That is, a count value Ci of an actual symbol Si may increase by 1. At this time, the symbol counting part 2710 may increase the total symbol number by 1. In step S530, the symbol counting part 2710 may judge whether an input symbol is a last symbol of the data chunk 2001, based on the total symbol number.

If the input symbol is judged not to be the last symbol, the write method proceeds to step S510. The steps S210 to S230 may be repeated until the input symbol is judged to be the last symbol. If the input symbol is judged to be the last symbol, the write method proceeds to step S540, in which a data deviation calculating part 2720 may calculate a data deviation σ based on the ideal symbol number X and count values Ci generated by the symbol counting part 2710. Calculation of the data deviation σ may be made according to the above-described equation. Herein, the ideal symbol number X may be determined by a data chunk size and a symbol size. The ideal symbol number X may be calculated by the data deviation calculating part 2720 using a data chunk size and a symbol size or set to a fixed value.

In step S550, a compression decision part 2730 may judge whether a value of the data deviation σ calculated by the data deviation calculating part 2720 exceeds the first reference value σ_{TH1}. If a value of the data deviation σ calculated by the data deviation calculating part 2720 does not exceed the first reference value σ_{TH1}, the write method proceeds to step S560, in which the compression function of the compression block 2500 is inactivated. That a value of the data deviation σ calculated by the data deviation calculating part 2720 does not exceed the first reference value σ_{TH1}, means that a deviation between the ideal symbol number X and the actual symbol number Ci is small. In other words, the smaller a deviation between the ideal symbol number X and the actual symbol number Ci, the higher the probability that data in a buffer 2400 is compressed data. For this reason, the compression function of the compression block 2500 may be inactivated. The activation of the compression function of the compression block 2500 may be made in hardware or in software.

If a value of the data deviation σ calculated by the data deviation calculating part 2720 exceeds the first reference value σ_{TH1}, the write method proceeds to step S570. In step S570, the compression decision part 2730 may judge whether a value of the data deviation σ is greater than the first reference value σ_{TH1} and less than the second reference value σ_{TH2}. If a value of the data deviation σ calculated by the data deviation calculating part 2720 exceeds the second reference value σ_{TH2}, the write method proceeds to step S580, in which a compression function of a compression block 2500 may be activated. That a value of the data deviation σ calculated by the data deviation calculating part 2720 exceeds the second reference value σ_{TH1}, means that a deviation between the ideal symbol number X and the actual symbol number Ci is large. In other words, the greater a deviation between the ideal symbol number X and the actual symbol number Ci, the higher the probability that data in a buffer 2400 is raw data. For this reason, the compression function of the compression block 2500 may be activated. The activation of the compression function of the compression block 2500 may be implemented in hardware or in software.

If a value of the data deviation σ is greater than the first reference value σ_{TH1} and less than the second reference value σ_{TH2}, the write method proceeds to step S590, in which the compression decision part 2730 may decide whether to compress data, based on an additional condition. For example, the compression decision part 2730 may decide whether to compress data, based on a result of a data deviation detecting operation previously executed as the additional condition. If the result of the previously performed data deviation detecting operation corresponds to activation of a compression function, the compression decision part 2730 activates a compression function of the compression block 2500. If the result of the previously performed data deviation detecting operation corresponds to inactivation of a compression function, the compression decision part 2730 inactivates a compression function of the compression block 2500. Under the above assumption, if a value of the data deviation σ is greater than the first reference value σ_{TH1} and less than the second reference value σ_{TH2}, there is selected a compression algorithm different from that used in step S580.

Afterwards, as activation or inactivation of the compression block 2500 is decided as described above, data stored in the buffer 2400 may be compressed by the compression block 2500 under the control of CPU 2300 (or, firmware executed by the CPU 2300) and stored in the storage media 1000, or directly stored in the storage media 1000 without performing further compression.

FIG. 8 is a diagram for describing data compression of a data storage device described in FIG. 7 according to another exemplary embodiment.

A data deviation σ may be calculated as described in FIGS. 3 to 5. If the calculated data deviation σ is less than the first reference value σ_{TH1}, as described in FIG. 8, the compression ratio may be low. That the compression ratio is low indicates that a size of data compressed by a compression block 2500 is large. That is, that the calculated data deviation σ is less than the first reference value σ_{TH1}, indicates that the compression ratio of data stored in a buffer 2400 is low. Accordingly, it is possible to predict the compression efficiency of data in the buffer 2400, together with judging whether data in the buffer 2400 is compressed data.

If the calculated data deviation σ is greater than the second reference value σ_{TH2}, as described in FIG. 8, the compression ratio may be high. The compression ratio may be decided by dividing a size of compressed data by a size of uncompressed data. That the compression ratio is high indicates that a size of data compressed by a compression block 2500 is small. That is, that the calculated data deviation σ is greater than the second reference value σ_{TH2}, indicates that the compression ratio of data stored in a buffer 2400 is high.

In the event that the calculated data deviation σ is greater than the first reference value σ_{TH1} and less than the second reference value σ_{TH2}, as illustrated in FIG. 8, it is difficult to decide whether the compression ratio is high or low. In this case, as described in FIG. 7, compression decision may be made based on an additional condition (for example, a result of a previously performed data deviation detecting operation). For example, when a result of a previously performed data deviation detecting operation corresponds to activation of a compression function, a compression block 2500 may be enabled. When a result of a previously performed data deviation detecting operation corresponds to inactivation of a compression function, the compression block 2500 may be disabled.

There is described an example that the data deviation detecting operation described in FIG. 7 is implemented through the data deviation detecting block 2700 in FIG. 3 in hardware. But, it is well understood that the data deviation detecting operation described in FIG. 7 may be implemented in software. For example, a program for executing the data deviation detecting operation may be stored in ROM 2600 illustrated in FIG. 2. The program, for example, may be included in the above-described memory translation layer. The data deviation detecting operation of the memory translation layer may be performed under the control of CPU 2300 illustrated in FIG. 2. In this case, although not illustrated in figures, a controller 2000 may be configured to have remaining elements 2100 to 2600 other than the data deviation detecting block 2700 in FIG. 2.

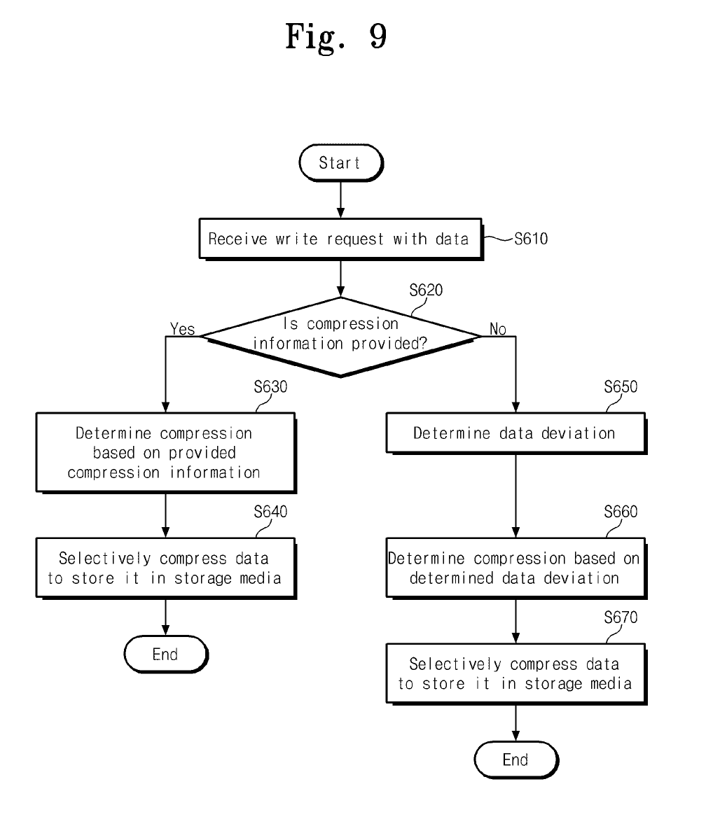

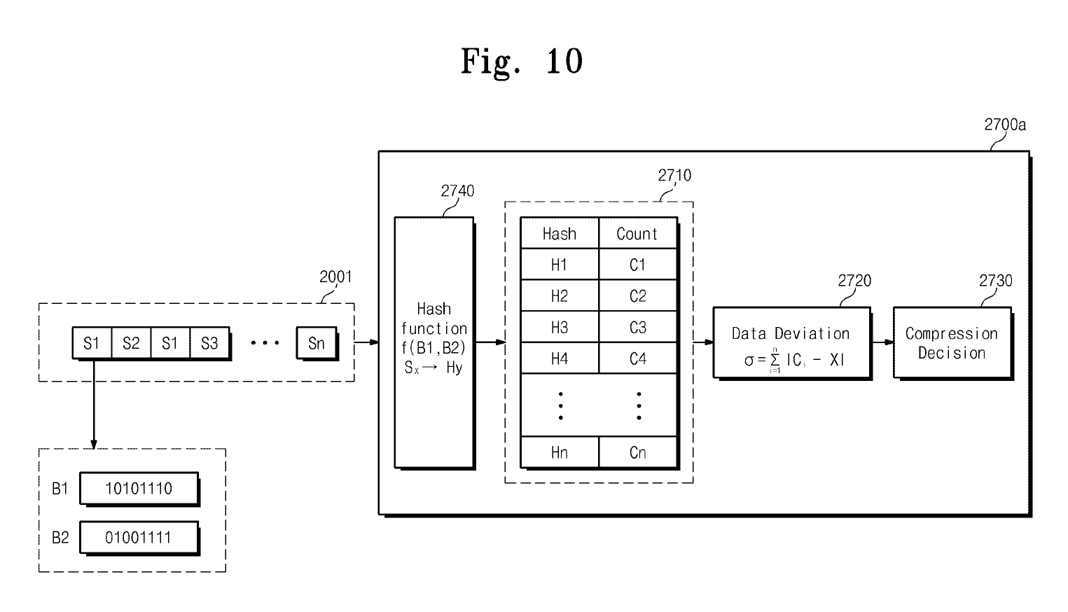

FIG. 9 is a flow chart for describing a write method of a data storage device according to another exemplary embodiment.

In step S610, data being stored in a storage media 1000 may be stored in a buffer 2400 at a write request. Once data being stored in the storage media 1000 is stored in the buffer 2400, in step S620, there is judged whether compression information on data transferred at the write request is sent therewith. This may be performed by a host interface 2100 or CPU 2300 (or, firmware executed by the CPU 2300). The compression information may be information indicating whether data transferred at the write request is compressed data or uncompressed/raw data. If the compression information on the data transferred at the write request is sent therewith, the write method proceeds to step S630, in which activation of a compression block 2500 is decided according to the provided compression information. In step S640, data stored in the buffer 2400 may be compressed or uncompressed according to the decision result, and resultant data (that is, compressed or uncompressed data) may be stored in the storage media 1000. Afterwards, the write method ends.

Returning to step S620, if the compression information on the data transferred at the write request is not sent therewith, the write method proceeds to step S650, in which a data deviation is decided in the same manner as described above. In step S660, whether to compress data is decided based on the decided data deviation. This may be made the same as described in FIG. 5 or 7. In step S670, data stored in the buffer 2400 may be compressed or uncompressed according to the decision result, and resultant data (that is, compressed or uncompressed data) may be stored in the storage media 1000. Afterwards, the write method ends.

FIG. 10 is a block diagram of a data deviation detection block illustrated in FIG. 2 according to an exemplary embodiment. A data deviation detecting block 2700a illustrated in FIG. 10 is substantially identical to that in FIG. 3 except a hash function part 2740 is added therein, and description thereof is thus omitted.

Each of symbols S1 to Sn included in a data chunk 2001 may be formed of at least two bytes B1 and B2 as illustrated in FIG. 10. The hash function part 2740 may be configured to change each symbol into a hash value according to a predetermined function f(B1,B2). For example, the hash function part 2740 may be configured to generate an 11-bit hash value based on a 2-byte symbol. A manner of generating a hash value is well understood and its description is thus omitted. A hash value changed via the hash function part 2740 is sent to a symbol counting part 2710 which may count the occurrence number of each hash value as described in FIG. 10. Afterwards, a data deviation σ is calculated based on a count value Ci of the occurrence number of each hash value in the same manner as described in FIG. 3. It is possible to reduce a space needed to store count values by changing (or, converting) a 16-bit symbol into an 11-bit hash value.

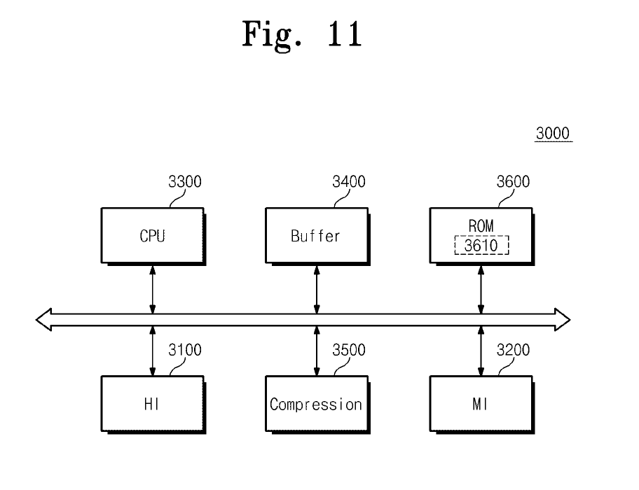

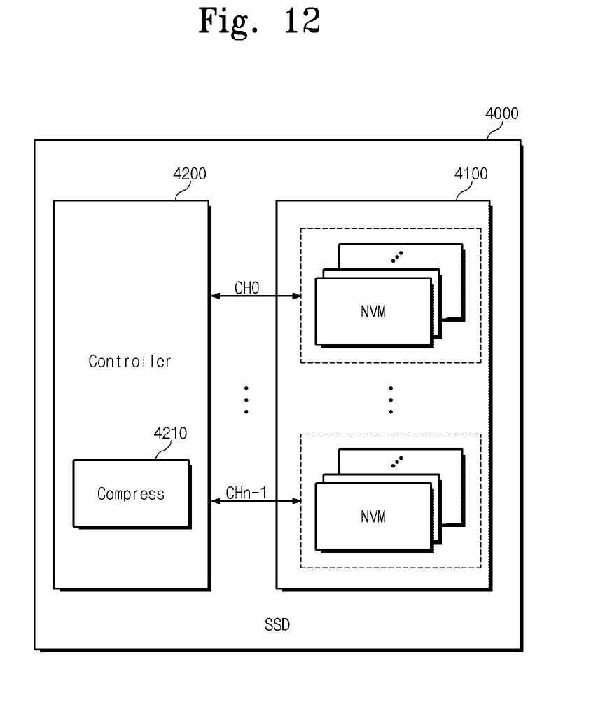

FIG. 11 is a block diagram of a controller illustrated in FIG. 1 according to another exemplary embodiment.

Referring to FIG. 11, a controller 3000 may include the first interface 3100, the second interface 3200, CPU 3300 as a processing unit, a buffer 3400, a compression block 3500, and ROM 3600. The elements 3100 to 3500 in FIG. 11 are substantially identical to those in FIG. 2, and description thereof is thus omitted. The ROM 3600 may store firmware 3610 (for example, a memory translation layer) supporting a data deviation detecting function which is described above. The firmware 3610 in the ROM 3600 may be executed by the CPU 3300. The controller 3000 in FIG. 11 may operate in the same manner as described in FIG. 2, except a data deviation detecting function is executed in software.

FIG. 12 is a block diagram illustrating a solid state drive to which a data deviation detecting scheme according to exemplary embodiments is applied.

Referring to FIG. 12, a solid state drive (SSD) 4000 may include a storage media 4100 and a controller 4200. The storage media 4100 may be connected with the controller 4200 via a plurality of channels CH0 to CHn−1. Each of the channels CH0 to CHn−1 is connected commonly with a plurality of non-volatile memories NVM. The controller 4200 may include a compression block 4210 which compresses data and releases compression of data. A compression function of the compression block 4210 may be selectively activated according to a data deviation σ which is obtained in the same manner as described in FIGS. 2 to 11. That is, activation/inactivation of the compression function of the compression block 4210 may be implemented in software or in hardware. If activation/inactivation of the compression function of the compression block 4210 is made in hardware, although not shown in FIG. 12, the controller 4200 may further comprise a data deviation detecting block 2700 described in FIG. 2.

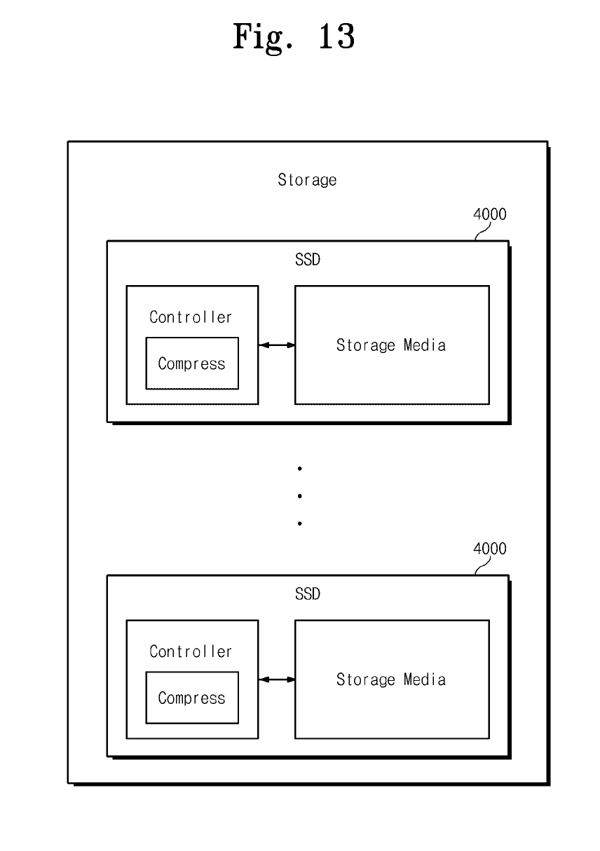

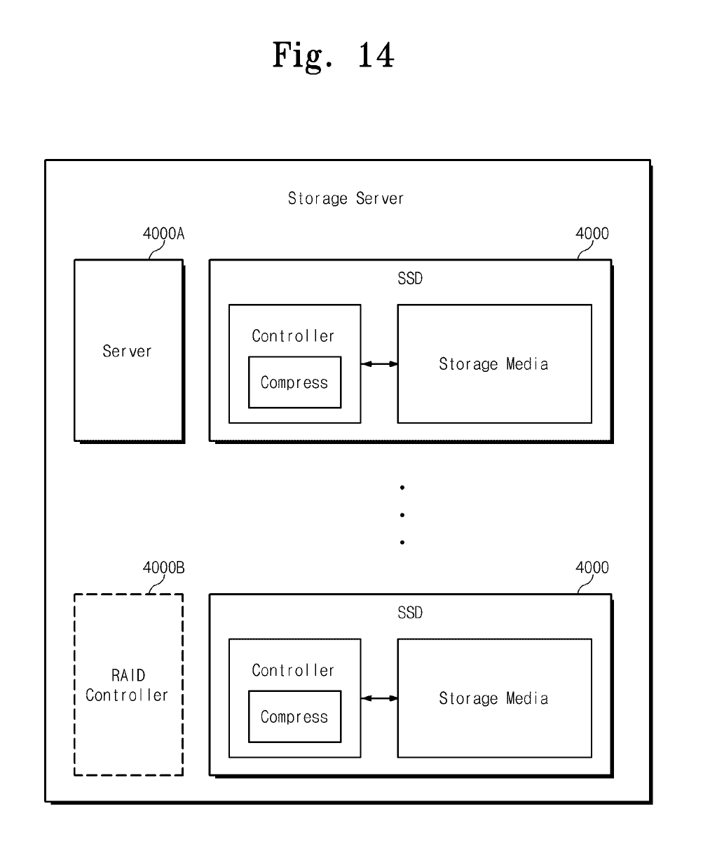

FIG. 13 is a block diagram of storage using a solid state drive illustrated in FIG. 12, and FIG. 14 is a block diagram of a storage server using a solid state drive illustrated in FIG. 12.

An SSD 4000 according to an exemplary embodiment of the inventive concept is used to configure the storage. As illustrated in FIG. 13, the storage includes a plurality of solid state drives 4000 which are configured to be substantially identical to that described in FIG. 12. The SSD 4000 according to an exemplary embodiment is used to configure a storage sever. As illustrated in FIG. 14, a storage server includes a plurality of solid state drives 4000, which are configured to be substantially identical to that described in FIG. 12, and a server 4000A for controlling an overall operation of the storage server. Further, it is well comprehended that the storage server may further include a RAID controller 4000B for parity management according to a parity manner applied to repair defects on data stored in the solid state drives 4000.

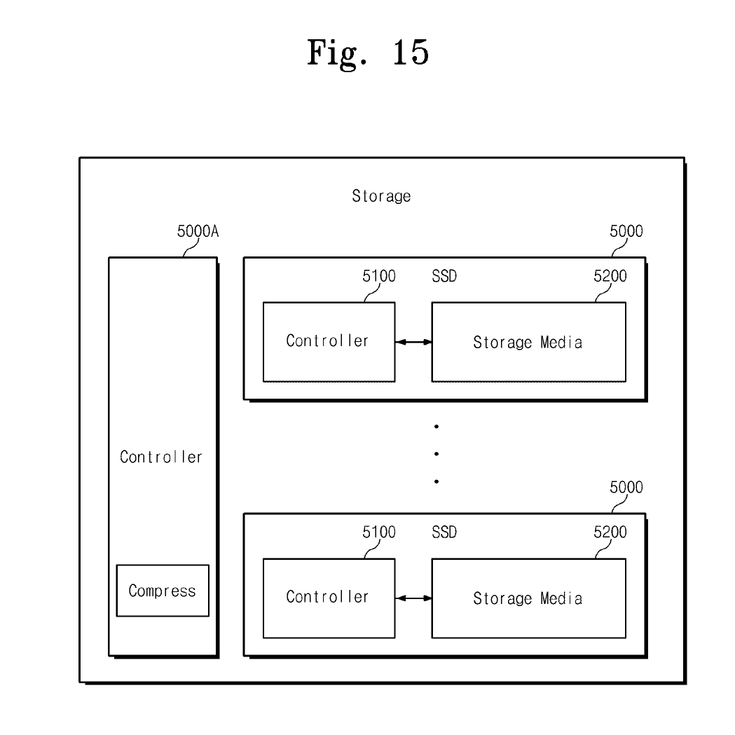

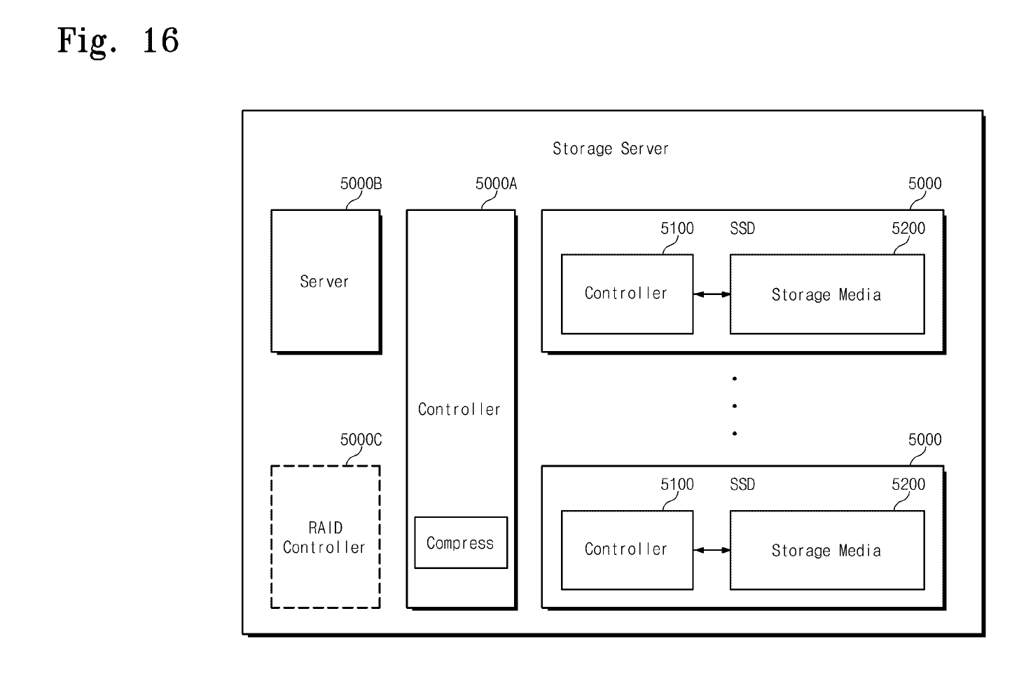

FIG. 15 is a block diagram illustrating storage according to another exemplary embodiment, and FIG. 16 is a block diagram of a storage server using storage illustrated in FIG. 15.

Referring to FIG. 15, the storage may include a plurality of solid state drives 5000 and a control block 5000A. Each of the solid state drives 5000 includes a controller 5100 and a storage media 5200. The controller 5100 performs an interface with the storage media 5200. The solid state drives 5000 are controlled by the control block 5000A, which is configured to perform the above-described function (for example, a data deviation detecting function). The storage configuration in FIG. 15 may be used to form a storage server. As illustrated in FIG. 16, the storage server the storage 5000 and a server 5000B. It is well comprehended that the storage server may further include a RAID controller 5000C for parity management according to a parity manner applied to repair defects on data stored in the solid state drives 5000.

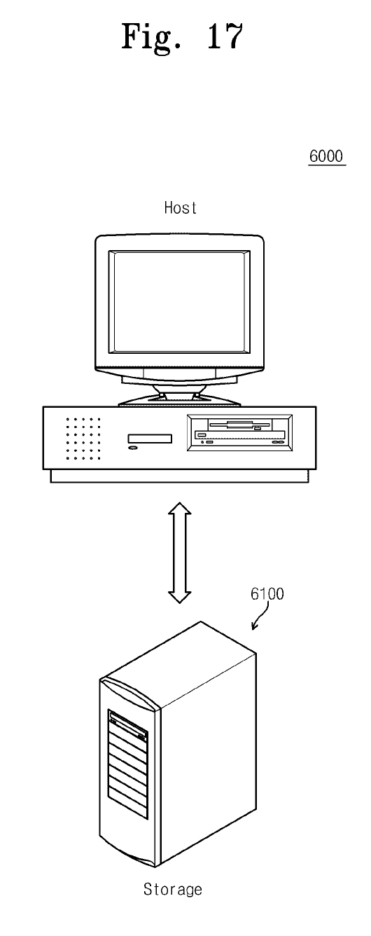

FIGS. 17 through 19 are diagrams illustrating systems utilizing a data storage device according to exemplary embodiments.

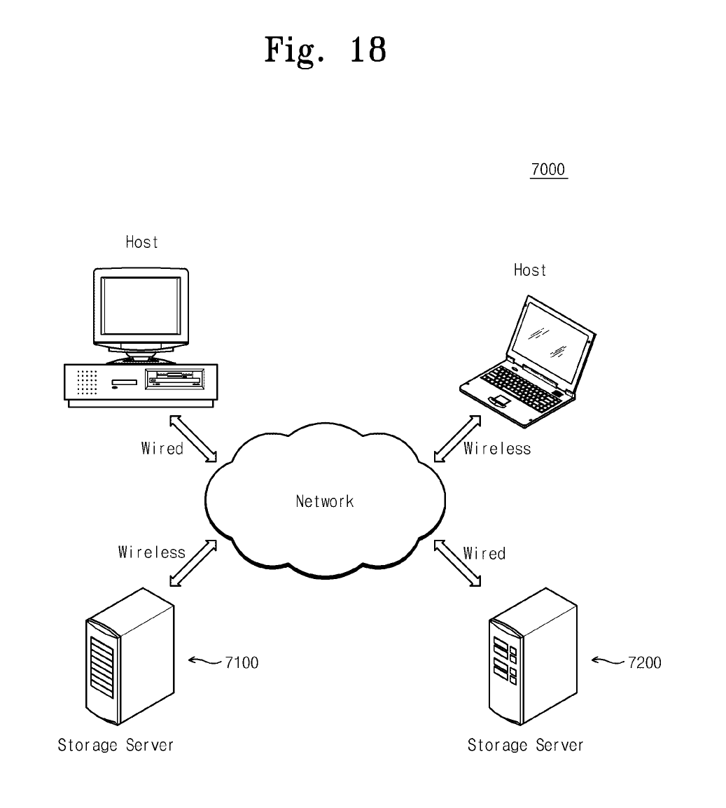

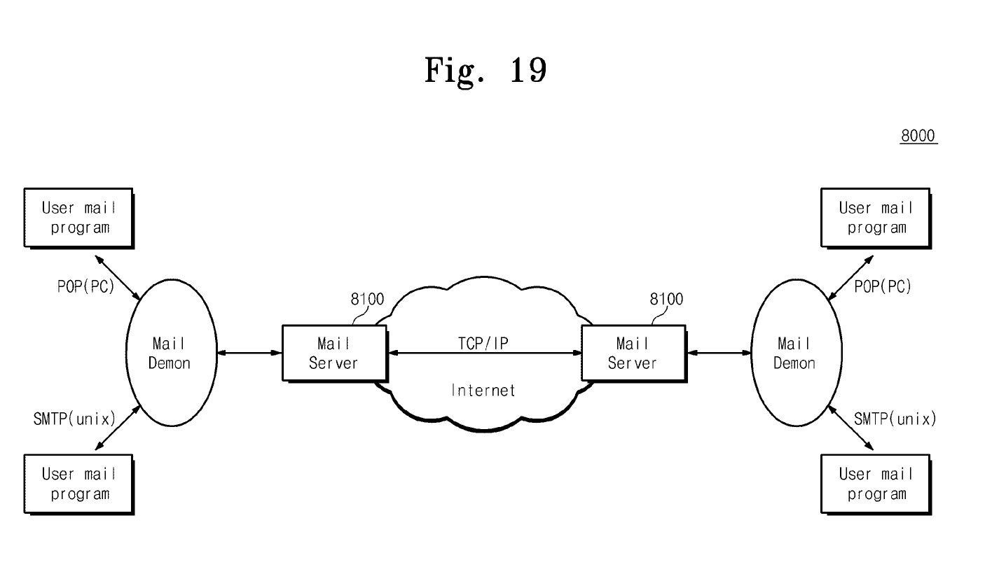

In the event that a solid state drive including a data storage device according to exemplary embodimentsis applied to the storage, as illustrated in FIG. 17, a system 6000 includes the storage 6100 which communicates with a host by a wire or wireless manner. In a case where a solid state drive including a data storage device according to exemplary embodiments is applied to a storage server, as illustrated in FIG. 18, a system 7000 includes storage servers 7100 and 7200 which communicate with a host by a wire or wireless manner. Further, as illustrated in FIG. 19, a solid state drive including a data storage device according to exemplary embodiments can be applied to a mail server 8100. The mail server 8100 may communicate with mail programs via a mail demon connected in POP and SMTP manners, and the mail servers 8100 may communicate through an internet network. The mail server 8100 may communicate with mail programs via a mail demon connected in POP and SMTP manners, and the mail servers 8100 may communicate through an internet network.

A non-volatile memory device according to an exemplary embodiment is a memory device which retains data even at power-off. With increases in mobile devices such as cellular phone, PDA digital camera, portable gate console, and MP3P, a flash memory device is widely used as not only data storage but also code storage. The flash memory device, further, is capable of being used at home applications such as HDTV, DVD, router, and GSP.

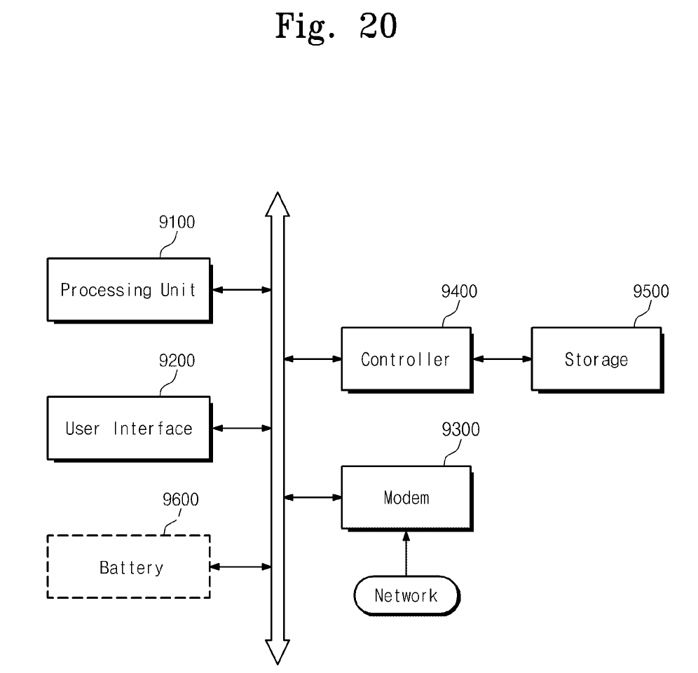

FIG. 20 is a block diagram illustrating a computing system including a non-volatile memory device according to an exemplary embodiment.

A computing system includes a processor 9100, a user interface 9200, a modem 9300 such as a baseband chipset, a memory controller 9400, and a storage media 9500 formed of a flash memory as a non-volatile memory device. The memory controller 9400 may be configured identically with that illustrated in FIG. 11. N-bit data (N being an integer equal to or greater than 1) processed/to be processed by the processing unit 9100 is stored in the storage media 9500 through the memory controller 9400. In the event that the computing system is a mobile device, a battery 9600 is further included in the computing system to supply an operating voltage thereto. Although not illustrated in FIG. 20, the computing system further comprises an application chipset, a camera image processor (CIS), a mobile DRAM, and the like. The memory controller 9400 and the storage media 9500 may constitute a Solid State Drive (SSD) which uses a non-volatile memory to store data, for example.

In an exemplary embodiment, a compression block 2500 of a controller 2000 may include one of the following compression algorithms or a combination of two or more thereof. The compression algorithms may includes LZ77&LZ78, LZW, Entropy encoding, Huffman coding, Adpative Huffman coding, Arithmetic coding, DEFLATE, JPEG, and the like.

In an exemplary embodiment, the first interface 2100/3100 of the controller 2000/3000 may be formed of one of computer bus standards, storage bus standards, and iFCPPeripheral bus standards, or a combination of two or more standards. The computer bus standards may include S-100 bus, Mbus, Smbus, Q-Bus, ISA, Zorro II, Zorro III, CAMAC, FASTBUS, LPC, EISA, VME, VXI, NuBus, TURBOchannel, MCA, Sbus, VLB, PCI, PXI, HP GSC bus, CoreConnect, InfiniBand, UPA, PCI-X, AGP, PCIe, Intel QuickPath Interconnect, Hyper Transport, etc. The storage bus standards may include ST-506, ESDI, SMD, Parallel ATA, DMA, SSA, HIPPI, USB MSC, FireWire(1394), Serial ATA, eSATA, SCSI, Parallel SCSI, Serial Attached SCSI, Fibre Channel, iSCSI, SAS, RapidIO, FCIP, etc. The iFCPPeripheral bus standards may include Apple Desktop Bus, HIL, MIDI, Multibus, RS-232, DMX512-A, EIA/RS-422, IEEE-1284, UNI/O, 1-Wire, 12C, SPI, EIA/RS-485, USB, Camera Link, External PCIe, Light Peak, Multidrop Bus, etc.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

What is claimed is:

1. A write method of a data storage device including a storage media, the write method comprising:
receiving data to be stored in the storage media;
judging whether the received data is compressed data, without externally provided additional information; and
selectively compressing the received data according to the judgment result,
wherein the judging whether the received data is compressed data is made based on a distribution of actual symbols included in at least part of the received data.

2. The write method of claim 1, further comprising storing the received data in the storage media without further compression when the received data is compressed data.

3. The write method of claim 2, further comprising compressing the received data to store the compressed data in the storage media when the received data is raw data.

4. The write method of claim 1, wherein the at least part of the received data includes a data chunk which forms a compression unit and includes a plurality of symbols.

5. The write method of claim 4, wherein the distribution of the actual symbols is determined according to a data deviation which is calculated based on count values of actual symbols included in the data chunk and an ideal symbol number of the plurality of symbols.

6. The write method of claim 4, wherein the judging whether the received data is compressed data includes calculating the data deviation by summing differences between each of the actual symbol numbers and the ideal symbol number.

7. The write method of claim 6, wherein when a value of the data deviation exceeds a reference value, the received data is judged to be raw data.

8. The write method of claim 6, wherein when no value of the data deviation exceeds a reference value, the received data is judged to be compressed data.

9. A data storage device comprising:
a storage media; and
a controller configured to control the storage media,
wherein the controller is configured to judge whether data to be stored in the storage media is compressed data without externally provided additional information and to selectively compress the data to be stored in the storage media according to the judgment result, the judging whether the received data is compressed data being made based on a distribution of actual symbols included in at least part of the received data.

10. The data storage device of claim 9, wherein when the received data is compressed data, the controller stores the data to be stored in the storage media without performing further compression.

11. The data storage device of claim 10, wherein when the received data is raw data, the controller compresses the data to be stored in the storage media and stores the compressed data in the storage media.

12. The data storage device of claim 9, wherein the controller comprises:
a compression block configured to compress the data to be stored in the storage media; and
a data deviation detecting block configured to decide a distribution of actual symbols included in the data to be stored in the storage media according to a part of the data to be stored in the storage media and to judge whether to compress data with respect to the data to be stored in the storage media according to the decision result,
wherein the compression block is activated according to the a judgment result of whether to compress data.

13. The data storage device of claim 12, wherein the data deviation detecting block comprises:
a symbol counting part configured to count actual symbols included in a data chunk among the data to be stored in the storage media;
a data deviation calculating part calculating a data deviation by summing differences between count values of the actual symbols counted by the symbol counting part and an ideal symbol number; and
a compression decision part deciding whether the data to be stored in the storage media is compressed data, based on the calculated data deviation.

14. The data storage device of claim 13, wherein the data chunk is formed of a plurality of symbols, and the ideal symbol number is an average symbol number of the plurality of symbols.

15. The data storage device of claim 13, wherein the data to be stored in the storage media is judged to be raw data when a value of the data deviation exceeds a reference value and to be compressed data when a value of the data deviation exceeds the reference value.

16. The write method of claim 6, wherein the ideal symbol number is an average symbol number of expressible symbols decided according to a symbol size.

17. A method of writing data in a storage medium, the method comprising:
determining whether the data is compressed data based on a characteristic of the data;
writing the data to the storage medium without performing data compression if a determination result indicates that the data is already compressed;
compressing the data before writing the data to the storage medium if the determination result indicates that the data is uncompressed,
wherein the data characteristic on which the determination is based is a distribution of actual symbols in at least part of the received data.

18. The method of claim 17, wherein the at least part of the received data is a data chunk, and the distribution of actual symbols in the data chunk is calculated as a data deviation value.

19. The method of claim 18, wherein data is determined to be uncompressed data when a data deviation value exceeds a reference value.

20. The method of claim 18, wherein data is determined to be compressed data when no data deviation value exceeds a reference value.
